(19) United States
(12) Patent Application Publication
(10) Pub. No.: US 2013/0162684 A1
(43) Pub. Date: Jun. 27, 2013

(54) SYSTEM AND METHOD FOR LOCKING THE ORIENTATION OF A DISPLAY ON A MOBILE

(71) Applicant: barnesandnoble.com llc, New York, NY (US)

(72) Inventor: David John WILLIAMS, San Francisco, CA (US)

(73) Assignee: barnesandnoble.com llc, New York, NY (US)

(21) Appl. No.: 13/650,945

(22) Filed: Oct. 12, 2012

Related U.S. Application Data
(60) Provisional application No. 61/547,621, filed on Oct. 14, 2011.

(51) Int. Cl. G09G 5/36

(52) U.S. Cl. CPC G09G 5/363
USPC 345/650

(57) ABSTRACT

An orientation sensor in a mobile electronic device senses a change in the orientation of the device, e.g., from a landscape orientation to a portrait orientation. The system and method of the present invention takes advantage of the time required for reformatting to display an orientation lock icon on the screen while reflow processing is taking place. The lock icon is a virtual button the user can tap to allow or disallow the information on the display to change orientation as the user rotates the device from landscape to portrait orientation or vice versa. Once the reflow processing is complete and the information has been redrawn in the new orientation, the lock icon is removed.

### CROSS-REFERENCE TO RELATED APPLICATION

This application claims benefit of U.S. Provisional Application No. 61/547,621, filed Oct. 14, 2011, which is hereby incorporated by reference,

### FIELD OF THE INVENTION

The present invention generally relates to displays on a mobile device, and more particularly displays that change orientation based on a detected orientation of the mobile device.

### BACKGROUND OF THE INVENTION

Most portable mobile devices are rectangular in shape, having rectangularly shaped displays. However, not all of the applications operable on the mobile device will utilize the display in the same orientation. Some applications work better when presented in a portrait orientation such as for a phone while others are more intuitive in a landscape orientation such as game playing, while some may work equally well in either orientation such as an electronic reader, depending on a personal preference.

integrating motion/orientation sensing technology with touch screen displays allows the portable mobile device to automatically reconfigure itself for a different mode of operation without the user having to delve into the intricacies of the user interface to manipulate the functions.

However, sometimes a user would like to lock the orientation of the display of the device regardless of the output of the orientation sensing mechanism.

### SUMMARY OF THE INVENTION

The present invention relates to the operation of a user interface screen in the transition from one physical orientation of a mobile device to a second orientation. An orientation sensor in the device senses the change in the orientation of the device, from a landscape orientation to a portrait orientation. Although the sensing of this orientation happens almost instantaneously, there is significant processing time required to reformat or reflow the information displayed on the screen of the device from one orientation to the other. The present invention displays an orientation lock icon that provides visual feedback, post change state indication, and masks the reflow/reformatting processing time. The lock icon is a virtual button the user can tap to allow or disallow the information on the display to change orientation as the user rotates the device from landscape to portrait orientation or vice versa. Once the reflow processing is complete and the information has been redrawn in the new orientation, the lock icon is removed.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates user interface (UI) in a portrait mode While the device is in a portrait orientation;

FIG. 2 illustrates the device turned in a landscape orientation, while the UI is still in a portrait mode;

FIG. 3 depicts the UI in the portrait mode with the lock icon displayed;

FIG. 4 illustrates the UI being reoriented in a landscape mode with the lock icon displayed;

FIG. 5 illustrates the UI in the landscape mode with the lock icon no longer being displayed;

FIG. 6 illustrates a flow chart according to a method of the present invention; and

FIG. 7 illustrates the components of an exemplary device.

### DETAILED DESCRIPTION OF THE INVENTION

In FIG. 1, the user is holding a mobile electronic device 130 in a portrait orientation. The user interface (UI) image 200, text of an electronic book throughout this example, is displayed on a display screen of the electronic device 130 in a portrait mode. Although the term “text” is used in this description to describe the content 200, the content 200 could be any types of content 200 that is reformatted or reprocessed for the new orientation. For example, content can be text that needs to be reflowed, a graph that needs to be relayed, a rich photograph that just takes a long time to move all the bits into the new orientation. The following discusses the process for driving the orientation, the formatting of the content 200, and the icons that appear or do not appear on the screen of the device 130 once the device 130 detects an orientation change.

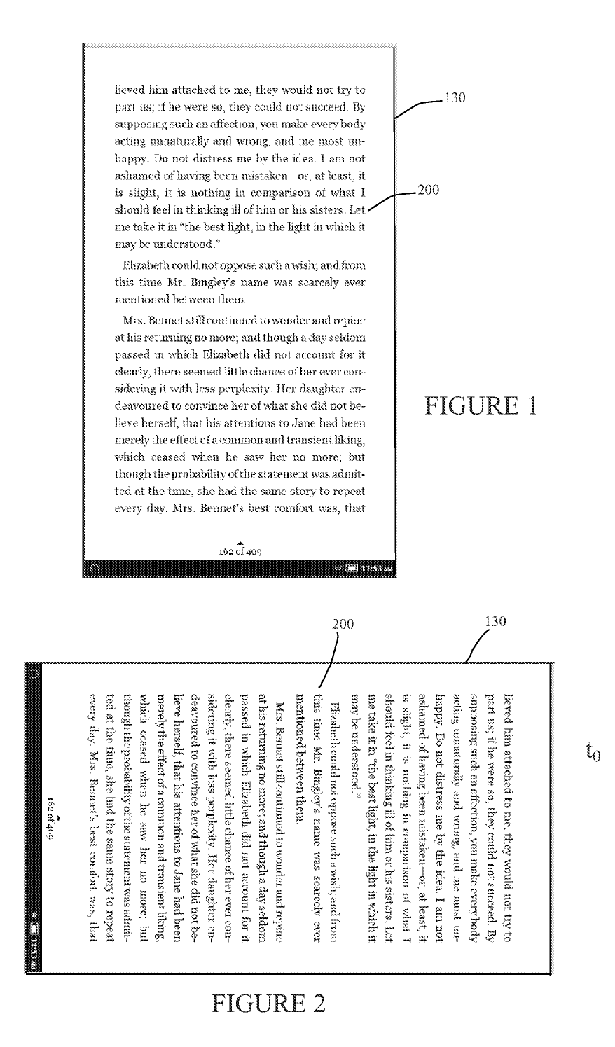

Consider time tₒ as the time that the orientation change of the device 130 from portrait to landscape is detected, as illustrated in FIG. 2. immediately, the reformatting or reflow of the page 200 to accommodate the new orientation of the device 130 commences in the circuitry of device 130. However, this reformatting of the image 200 takes some time to be accomplished.

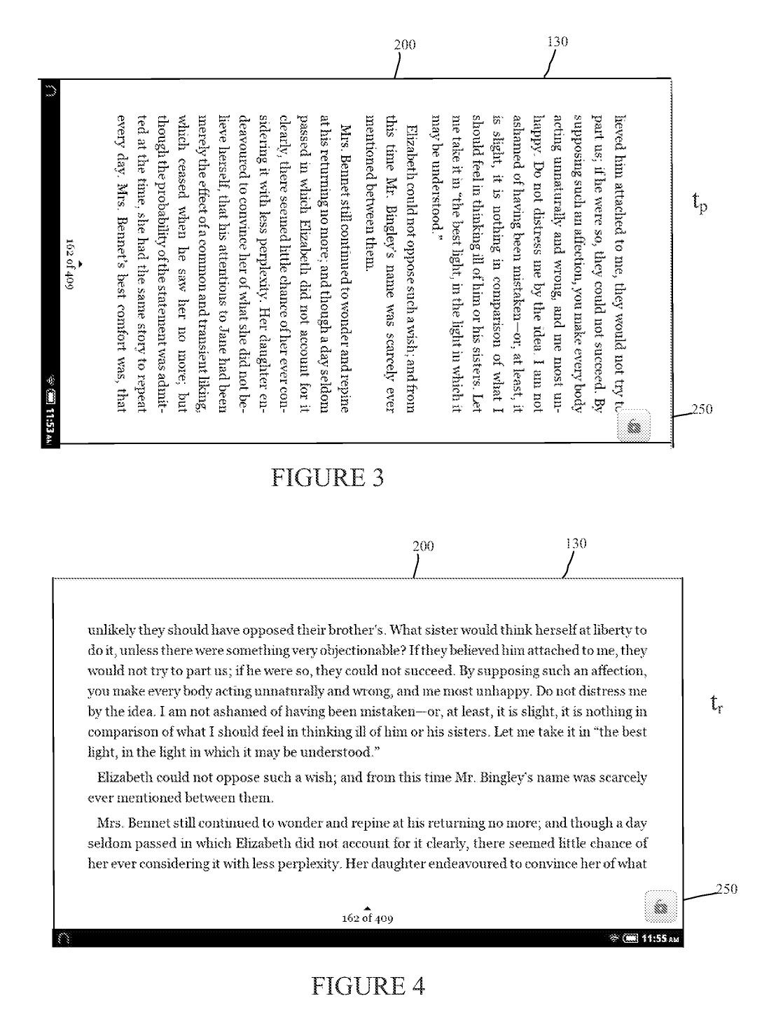

As shown in FIG. 3, at time tₚ, an orientation lock icon 250 is posted on the UI of the device 130. Note that the posting of icon 250 at time tₚ occurs while the content 200 is still in the portrait orientation as the reflow processing has not been completed. The orientation lock icon 250 represents the state of a content formatting lock contained in the system. The lock icon 250 further, by its orientation, represents the orientation in which the content 200 will be reformatted/reflowed. The lock icon 250 shows the orientation that will be used after a reformatting of the content. For example, if device 130 is in portrait and the user rotates the device, lock icon 250 is shown in a landscape orientation. This lock icon 250 further leads to the impression that the device is displaying in the new orientation quicker because the user's eye is drawn to the icon 250 at the front of the display, which is in the new orientation, and then the content 250 follows. The display of the icon 250 is also a good visual indicator to the user of what is happening in the processing in the device. Too often, devices are processing data and there is no indication to the user what is happening. In some cases, this lack of information to the user can lead her to believe that something is wrong with the device.

The lock icon 250 is a virtual button the user can tap to change the state of the content formatting lock to either allow or disallow the information 200 on the display of device 130 to change orientation/formatting as the user rotates the device from landscape to portrait orientation or vice versa. If the orientation is locked, the device 130 will not reflow/reformat the page 200 into the detected orientation, but rather keep the same content formatting as when the lock was turned on. i.e., portrait or landscape. If the orientation is not locked, the device 130 will reformat/reflow the content contained on page 200 into proper format for the detected orientation. In the Figures illustrated herein, the orientation reflow is unlocked, as indicated by the lock icon 250.

If user presses the lock icon 250, the system changes the state of the content formatting lock to the opposite state. For example, if the lock was enabled, the state changes to unlock to allow the reformatting of content 200. If the lock was disabled, the content formatting lock will change to locked, and the reformatting of the content 200 will not occur. Although not illustrated herein, there are other settings menus on device 130 that allow user to lock or unlock the content formatting lock without the detection of an orientation change as described herein. However, when the detection of the orientation change occurs, the display of the lock icon 250 is the most convenient way to allow the user to change the state of the content formatting lock.

As shown in FIG. 4, at time tᵣ, the reflow processing is completed and the page 200 is redrawn in the new landscape orientation, with the orientation lock 250 still being displayed.

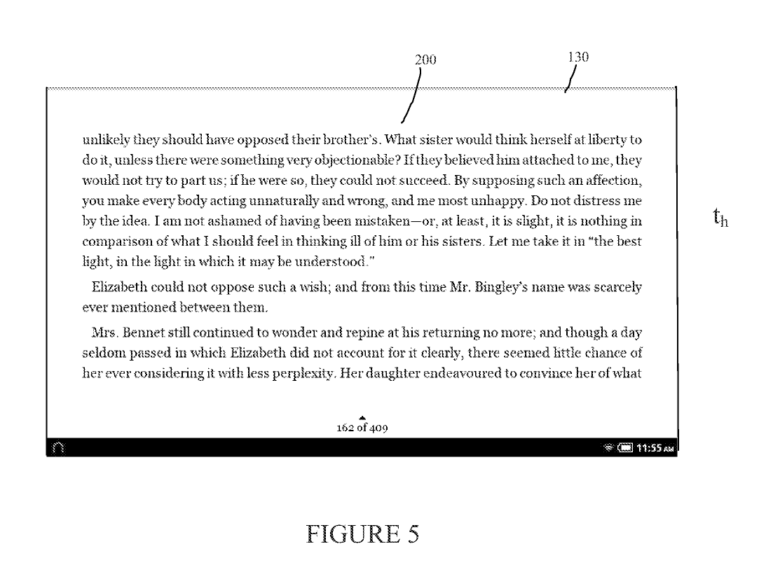

As shown in FIG. 5, at time tₕ, the orientation lock icon 250 is hidden.

Depending on the type of content 200 being displayed, it is possible that tᵣ is less than or greater than tₚ. Time tᵣ is indeterminate, but regardless, tₚ should be chosen to be the point in time when a typical user would be become impatient that nothing is happening on the screen of device 130. Something like tₚ=1 second might be preferable, but different timings can be used. On average tᵣ is approximately two seconds for electronic books on certain devices. On other devices, tᵣ may be much shorter or much longer.

One important feature of posting the orientation lock 250 before the reflow processing has been completed is that it can mask the slowness of the reflow process. The posting of the orientation lock 250 gives the user's eye something to be distracted by while the device 130 is performing the intensive processing involved in the reflow process. The posting of the orientation lock 250 is much like displaying a splash screen in that regard.

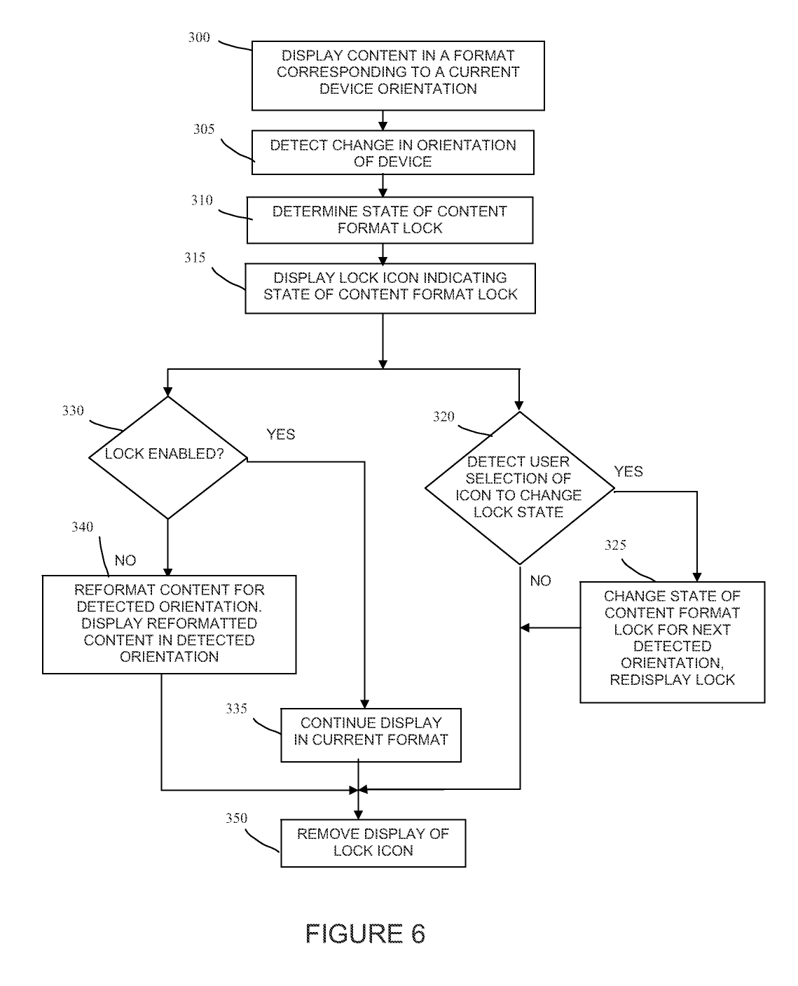

FIG. 6 is a flow chart illustrating an exemplary method of the present invention.

In act 300, the system displays the content 200 in a format that corresponds to the current orientation of the device 130, i.e., portrait or landscape. In act 305, the system detects a change in the orientation of the device 130. When a change in the orientation of the device 130 is detected, the system, in act 310 determines the state of the content format lock, e.g., enabled (locked) or disabled (unlocked). The system then, in act 315 displays the lock icon 250 on the device 130.

The system then performs two parallel operations, one for processing the content, if necessary, and one for processing the user's actions with respect to the lock icon 250, if any. Once the lock icon 250 is displayed, the user is able to select the lock icon 250 in order to change the state of the lock. The user's action, non-action, with respect to the icon 250 is detected in act 320. If the user activates the icon 250, the system in act 325 toggles the state of the content format lock to the opposite state, i.e., lock to unlock or unlock to lock. if the user does not select the lock icon 250, i.e., she is happy with the current state of the content format lock, no change in the content format lock is made and the process continues at step 350 where the lock icon 350 is removed after the parallel processing, if any, for reformatting the content is completed.

In act 330, the system determines whether the content format lock is enabled (locked) or disabled (unlocked). If the lock is enabled, the system continues to display the content 200 in the current format and does not perform a reformatting operation. in a preferred embodiment, the lock icon 250 remains displayed until the user returns the device 130 to its original orientation. If the user keeps the device 130 in the changed orientation, the system continues to display the lock icon 250 to allow the user to select the icon 250 to change the state of the content format lock and thus change the formatting of the content 200 to accommodate the new orientation.

If the content format lock is disabled (unlocked) the NO route out of determination 330 is taken and in act 340 the system reformats content 200 for the detected orientation. Once reformatted, the system displays the reformatted content in the new orientation. During the time the reformatting is occurring, the system continues the display of icon 250 and only removes it in act 350 after the reformatted content 200 is displayed in the new orientation,

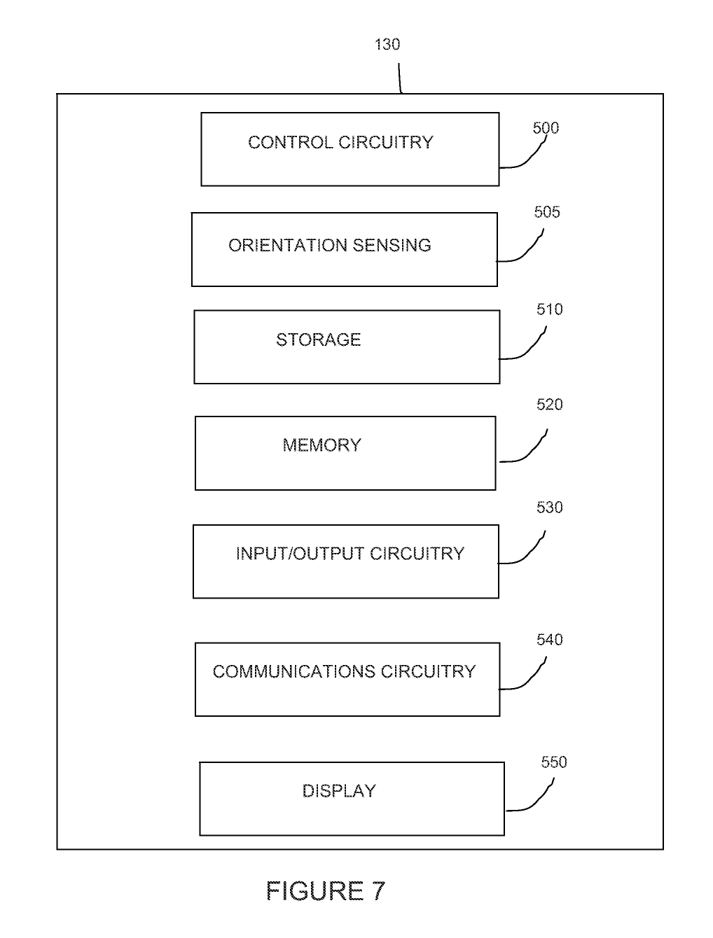

FIG. 7 illustrates an exemplary device 130. As appreciated by those skilled the art, the device 130 can take many forms capable of operating the present invention. As previously described, in a preferred embodiment the device 130 is a mobile electronic device, and in an even more preferred embodiment device 130 is an electronic reader device. Electronic device 130 can include control circuitry 500, storage 510, memory 520, input/output (“I/O”) circuitry 530, communications circuitry 540, and display 550. In some embodiments, one or more of the components of electronic device 130 can be combined or omitted, e.g., storage 510 and memory 520 may he combined. As appreciated by those skilled in the art, electronic device 130 can include other components not combined or included in those shown in this Figure, e.g., a power supply such as a battery, an input mechanism, etc.

Electronic device 130 can include any suitable type of electronic device. For example, electronic device 130 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 130 can include a larger portable electronic device, such as a laptop computer.

Control circuitry 500 can include any processing circuitry or processor operative to control the operations and performance of electronic device 130. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Orientation sensing component 505 includes orientation hardware such as, but not limited to, an accelerometer or a gyroscopic device and the software operable to communicate the sensed orientation to the control circuitry 500. The orientation sensing component 505 is coupled to control circuitry 500 that controls the various input and output to and from the other various components. The orientation sensing component 505 is configured to sense the current orientation of the portable mobile device 130 as a whole. The orientation data is then fed to the control circuitry 500 which control an orientation sensing application. The orientation sensing application controls the graphical user interface (GUI), which drives the display 550 to present the GUI for the desired mode.

Storage 510 can include, for example, one or more computer readable storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 130, firmware, user preference information data, e g., content preferences, authentication information, e.g. libraries of data associated with authorized users, transaction information data, e.g., information such as credit card information, wireless connection information data, e.g., information that can enable electronic device 130 to establish a wireless connection), subscription information data, e.g., information that keeps track of podcasts or television shows or other media a user subscribes to, contact information data, e.g., telephone numbers and email addresses, calendar information data, and any other suitable data or any combination thereof The instructions for implementing the functions of the present invention may, as non-limiting examples, comprise software and/or scripts stored in the computer-readable media 510.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. in some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 130. Although I/O circuitry 530 is illustrated in FIG. 6 as a single component of electronic device 130, several instances of I/O circuitry 530 can be included in electronic device 130.

Electronic device 130 can include any suitable interface or component for allowing a user to provide inputs to I/O circuitry 530. For example, electronic device 130 can include any suitable input mechanism, such as a button, keypad, dial, a click wheel, or a touch screen, e.g., display 550. In some embodiments, electronic device 130 can include a capacitive sensing mechanism, or a multi-touch capacitive sensing mechanism.

In some embodiments, electronic device 130 can include specialized output circuitry associated with output devices such as, for example, one or more audio outputs. The audio output can include one or more speakers, e.g., mono or stereo speakers, built into electronic device 130, or an audio component that is remotely coupled to electronic device 130, e.g., a headset, headphones or earbuds that can be coupled to device 130 with a wire or wirelessly,

Display 550 includes the display and display circuitry for providing a display visible to the user, For example, the display circuitry can include a screen, e.g., an LCD screen, that is incorporated in electronic device 130. In some embodiments, the display circuitry can include a coder/decoder (Codec) to convert digital media data into analog signals. For example, the display circuitry or other appropriate circuitry within electronic device 1 can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 130, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from electronic device 130 to other devices within the communications network. Communications circuitry 540 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOW, or any other suitable protocol.

Electronic device 130 can include one more instances of communications circuitry 540 for simultaneously performing several communications operations using different communications networks, although only one is shown in FIG. 6 to avoid overcomplicating the drawing. For example, electronic device 130 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, electronic device 130 can be coupled to a host device such as a remote servers for data transfers, synching the communications device, software or firmware updates, providing performance information to a remote source, e.g., providing riding characteristics to a remote server, or performing any other suitable operation that can require electronic device 130 to be coupled to a host device. Several electronic devices 130 can be coupled to a single host device using the host device as a server. Alternatively or additionally, electronic device 130 can be coupled to several host devices, e.g., for each of the plurality of the host devices to serve as a backup for data stored in electronic device 130.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A method for controlling a formatting of a display of content on an electronic device comprising:
detecting a first orientation of the electronic device;
displaying the content on a display screen of the electronic device in a first format corresponding to the first orientation;
detecting a change from the first orientation of the electronic device to a second orientation of the electronic device;
displaying a lock icon on the display screen, the lock icon indicating a state of a content formatting lock;
determining the state of the content formatting lock;
if the content formatting lock is unlocked:
reformatting the content from the first format to a second format, the second format corresponding to the second orientation,
displaying the content in the second format on the display screen, and
remove the display of the lock icon when the displaying of the content in the second format is complete; and
if the content formatting lock is locked:
continue to display the content in the first format on the display screen,
remove the display of the lock icon when the orientation of the electronic device is returned to the first orientation.

2. The method according to claim 1, further comprising:
detecting selection of lock icon; and
changing the state of the content formatting lock to an opposite state.

3. The method according to claim 1, wherein the first orientation of the device is a portrait orientation and the second orientation is a landscape orientation, the reformatting act further comprising reformatting the content from a format suitable for the portrait orientation to a format suitable for the landscape orientation.

4. The method according to claim 1, wherein the device is an electronic reader and the content is an electronic publication, the reformatting act further comprises reformatting the electronic publication in a format corresponding to the detected orientation.

5. The method according to claim 1, wherein the act of displaying the lock icon further comprises displaying the lock icon in the orientation in which the content will be displayed.

6. A non-transitory computer-readable media comprising a plurality of instructions that, when executed by at least one electronic device, cause the at least one electronic device to:
detect a first orientation of the at least one electronic device;
display the content on a display screen of the at least one electronic device in a first format corresponding to the first orientation;
detect a change from the first orientation of the at least one electronic device to a second orientation of the at least one electronic device;
display a lock icon on the display screen, the lock icon indicating a state of a content formatting lock;
determine the state of the content formatting lock;
if the content formatting lock is unlocked:
reformat the content from the first format to a second format, the second format corresponding to the second orientation,
display the content in the second format on the display screen, and remove the display of the lock icon when the display of the content in the second format is complete; and
if the content formatting lock is locked:
continue to display the content in the first format on the display screen,
remove the display of the lock icon when the orientation of the at least one electronic device is returned to the first orientation.

7. The non-transitory computer-readable media according to claim 6, wherein the instructions further cause the at least one electronic device to:
detect a selection of lock icon; and
change the state of the content formatting lock to an opposite state.

8. The non-transitory computer-readable media according to claim 6, wherein the first orientation of the device is a portrait orientation and the second orientation is a landscape orientation, wherein the instructions further cause the at least one electronic device to reformat the content from a format suitable for the portrait orientation to a format suitable for the landscape orientation.

9. The non-transitory computer-readable media according to claim 6, wherein the device is an electronic reader and the content is an electronic publication, wherein the instructions further cause the at least one electronic device to reformat the electronic publication in a format corresponding to the detected orientation.

10. The non-transitory computer-readable media according to claim 6, wherein the instructions further cause the at least one electronic device to display the lock icon in the orientation in Which the content will be displayed.

11. A system for formatting and displaying content on an electronic device comprising:
a memory that includes instructions for operating the electronic and at least one piece of content;
a display screen;
an orientation sensor
a touch sensitive input device; and
control circuitry coupled to the memory, coupled to the touch sensitive input device, coupled to the orientation sensor and coupled to the display screen, the control circuitry executing the instructions and is operable to:
detect a first orientation of the electronic device using the orientation sensor;
display the content on the display screen in a first format corresponding to the first orientation;
detect a change from the first orientation of the one electronic device to a second orientation of the electronic device;
display a lock icon on the display screen, the lock icon indicating a state of a content formatting lock;
determine the state of the content formatting lock;
if the content formatting lock is unlocked:
reformat the content from the first format to a second format, the second format corresponding to the second orientation,
display the content in the second format on the display screen, and
remove the display of the lock icon when the display of the content in the second format is complete; and
if the content formatting lock is locked:
continue to display the content in the first format on the display screen,
remove the display of the lock icon when the orientation of the at least one electronic device is returned to the first orientation.

12. The system according to claim 11, wherein the control circuitry executing the instructions is further operable to:
detect selection of lock icon; and
change the state of the content formatting lock to an opposite state.

13. The system according to claim 11, wherein the first orientation of the device is a portrait orientation and the second orientation is a landscape orientation, wherein the control circuitry executing the instructions is further operable to reformat the content from a format suitable for the portrait orientation to a format suitable for the landscape orientation.

14. The system according to claim 11, wherein the device is an electronic reader and the content is an electronic publication, wherein the control circuitry executing the instructions is further operable to reformat the electronic publication in a format corresponding to the detected orientation.

15. The system according to claim 11, wherein the control circuitry executing the instructions is further operable to display the lock icon in the orientation in which the content will be displayed
